(19) United States
(12) Patent Application Publication
(10) Pub. No.: US 2018/0126572 A1
(43) Pub. Date: May 10, 2018

(54) HEATING BLADES OF RAZOR USING RF ENERGY

(71) Applicant: Heated Blades Holding Company, LLC, Pompano Beach, FL (US)

(72) Inventors: Louis D. Tomassetti, Pompano Beach, FL (US); Felix Lazarev, Boca Raton, FL (US)

(21) Appl. No.: 15/343,833

(22) Filed: Nov. 4, 2016

(51) Int. Cl. B26B 21/48; B26B 21/40

(52) U.S. Cl. CPC B26B 21/48; B26B 21/4056

(57) ABSTRACT

A razor includes one or more blades that are directly or indirectly heated by RF energy. A processing element is connected to a radio frequency (RF) modulator which is coupled with an RF coupling and/or resonance chamber. The resonance chamber is spatially coupled with either the blades of the razor or, alternatively, one or more heating elements that are thermally coupled with the blades for transferring heat energy directly to the blades. An energy source provides the electric current required for operating the processing element and RF modulator. The RF modulator emits RF energy that is directed and amplified by the RF coupling/resonance chamber which warms the blades or heating elements.

### BACKGROUND OF THE INVENTION

### Field of the Invention

The present invention relates generally to razors for shaving and, more particularly, to a razor having one or more blades that are heated by RF energy.

### Discussion of the Related Art

It is known that the cutting edge of a razor blade cuts hair more effectively when it is warm or hot. It is also common practice to place the razor blades under hot running water in order to heat the blades just prior to stroking the blades over the skin in order to cut the hairs. However, the heat cutting performance of the blades lasts only a short time during the beginning of the shaving stroke. Within seconds, the temperature of the skin surface, hairs and blade are quickly reduced due to exposure to the ambient air. Ideally, it is best to maintain the blades, including the cutting edges of the blades, heated to a warm temperature throughout the shaving process to achieve better performance and increased shaving comfort.

One particular prior art blade heating invention, disclosed in U.S. Pat. No. 6,817,101 B1 to Bohmer, provides a razor with blades that are continuously heated throughout the shaving process. In Bohmer, heating the blades is attained by applying a measured amount of electric current to the blades by means of conductors connected to each side of the blade cartridge and extended in the form of contacts at the connection of the blade cartridge to a razor handle. Electric current is provided by a primary battery contained in a compartment in the razor handle. The electric current passing through the blades results in generation of heat in the blades. The degree of heat can be adjusted by means of resistors connected in series with the blades and the blade cartridge. A switch closes the circuit to allow electric current to flow through the blades.

U.S. Pat. No. 6,836,966 to Patrick discloses a heated razor having heating elements that are bonded to the bottom sides of the blades of the razor. The heating elements are activated by electric current and generate heat that is transferred to the blades by thermal conduction. Patrick requires an electrical connection, by wire conductors, between a battery source in the handle of the razor and the heating elements that are bonded to the blades.

The present invention eliminates the need to have an electrical connection between a battery source in the handle of the razor and the blades or a heating element positioned in contact with or near the blades. Specifically, the present invention uses RF energy generated by an RF modulator which is coupled with an RF coupling and/or resonance chamber. The resonance chamber is spatially coupled to the blades of the razor or alternatively, one or more heating elements that are thermally coupled with the blades for transferring heat energy directly to the blades. Accordingly, the present invention overcomes the problems and shortcomings associated with the need to have an electrical connection between a power source in the handle of the razor and the blades or heating element on the blade cartridge.

### SUMMARY OF THE INVENTION

The present invention is directed to a razor that includes one or more blades that are directly or indirectly heated by RF energy. The razor includes a processing element that is connected to an RF modulator which is coupled with an RF coupling and/or resonance chamber. The resonance chamber is spatially coupled with either the blades of the razor or, alternatively, one or more heating elements that are thermally coupled with the blades for transferring heat energy directly to the blades. An energy source provides the electric current required for operating the processing element and RF modulator. The RF modulator emits RF energy that is directed and amplified by the RF coupling/resonance chamber which warms the blades or heating elements. The blades or heating elements have a pre-set Curie temperature point that is monitored by the processor. The processor maintains the temperature of the blades (in the one embodiment) or the heating elements (in the other embodiment) within a desired temperature range that is at or near the pre-set Curie temperature point. When the temperature of the blades, in the one embodiment, or the heating elements, in the other embodiment, drifts away from the pre-set Curie temperature, as a result of exposure to water, skin, the surrounding atmospheric air or other elements, the processor increases the power limit to the RF modulator to thereby increase the temperature of the blades (or the heating elements) closer to the pre-set Curie temperature, thereby maintaining the temperature of the blades within the desired temperature range throughout the shaving process.

### Objects and Advantages of the Invention

Considering the foregoing, it is a primary object of the present invention to provide a wet shave razor for shaving and which includes one or more blades that are heated by RF energy without the need of wire conductors or other physical connections between a power source in the handle and the blade cartridge of the razor.

It is a further object of the present invention to provide a wet shave razor having one or more blades that are directly heated by RF energy to a desired temperature range without the need of wire conductors or other electric contacts between the handle of the razor and the blades and/or blade cartridge.

It is a further object of the present invention to provide a wet shave razor having one or more blades that are indirectly heated by RF energy to a desired temperature range without the need of wire conductors or other electric contacts between the handle of the razor and the blades and/or blade cartridge.

It is still a further object of the present invention to provide a wet shave razor for shaving that includes one or more blades that are heating directly or indirectly by RF energy, and wherein the razor includes a processing element for monitoring the blade temperature (or heating element temperature) and for controlling the emission of RF energy for maintaining the blades within the desired temperature range.

It is still a further object of the present invention to provide a wet shave razor for shaving that includes one or more blades that are heated by RF energy, and wherein the razor includes a processor and a power storage source, and wherein the processor monitors energy levels that are supplied by the power storage source in order to estimate the power limit that is available for disposal.

These and other objects and advantages of the present invention are more readily apparent with reference to the following detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a general schematic diagram illustrating the principal components of the razor of the present invention, in accordance with a first embodiment thereof; and

FIG. 2 is a general schematic diagram illustrating the principal components of the razor, in accordance with a second embodiment of the invention.

Like reference numerals refer to like components and parts throughout the several views in the drawings.

### DETAILED DESCRIPTION OF THE PREFERRED EMBODIMENTS

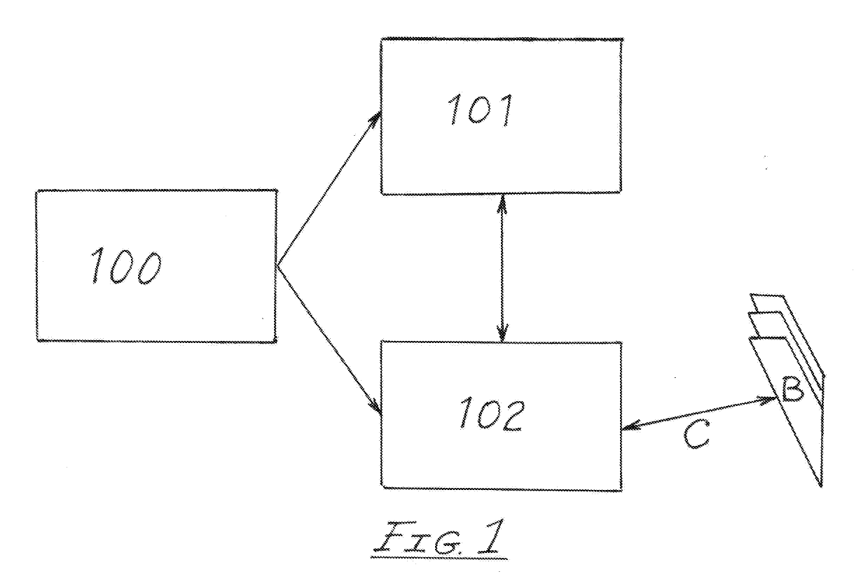

Referring initially to FIG. 1, a first embodiment of the invention is shown. The embodiment of FIG. 1 is directed to a razor having one or more blades (B) that are directly heated by RF energy. As shown in FIG. 1, a processing element 101 is directly connected to, or bi-directionally coupled with the radio frequency modulator 102 (RF modulator) for the purpose of controlling the RF modulator 102. More specifically, the processing element 101 provides a plurality of control signals that are necessary to operate the RF modulator 102. These control signals include, but are not limited to, signals to control the following functions: Enable, Power Limit, and Modulation Frequency. In return, the processing element 101 acquires a plurality of status signals back from the RF modulator 102. These status signals include, but are not limited to, signals that indicate the following: PLL (Phase Locked Loop) Locked, Measured SWR (Standing Wave Ratio), Power Consumption, and Tuning Coefficient. The RF modulator 102 is coupled with the RF coupling and or resonance chamber (C). The resonance chamber (C) is spatially coupled with the one or more blades (B) of the razor which have a pre-set or known Curie temperature. An energy source 100 provides the electric current that is required for operating the processing element 101 and RF modulator 102. The RF modulator 102 emits RF energy that is directed and amplified by RF coupling/resonance chamber (C), which in turn warms up the blades (B). The closer the blades are to the pre-set Curie temperature point, the less SWR is measured by the RF modulator 102, which in turn indicates processing element 101 to reduce the power limit to the levels that are necessary to sustain the required temperature of the blades (B). When water, skin and/or other elements come into contact with the blades (B), the temperature of the blades (B) inherently drifts away from the pre-set Curie temperature, which in turn increases the measured SWR, indicating to the processor element 101 to increase the power limit to the RF modulator 102, thus increasing the temperature of the blades (B) closer to the Curie temperature, at which point the process repeats. The processing element 101 additionally monitors energy levels that are supplied by the energy source 100 in order to estimate the power limit that is available for disposal.

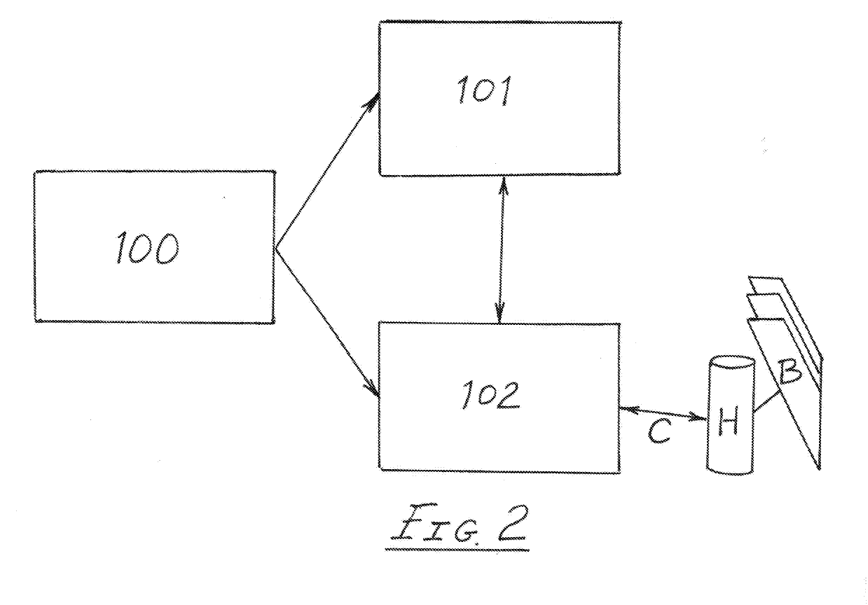

Referring now to FIG. 2, a second embodiment of the invention is shown and is directed to a razor having one or more blades (B) that are indirectly heated by RF energy. Specifically, a processing element 101 is directly connected to, or bi-directionally coupled with the radio frequency modulator 102 (RF modulator) for the purpose of controlling the RF modulator 102. Similar to the first embodiment of FIG. 1, the processing element 101 provides plurality of control signal that are necessary to operate the RF modulator 102 including, but not limited to: Enable, Power Limit, and Modulation Frequency. In return, the processing element 102 acquires a plurality of status signals back from the RF modulator 102. These status signals include, but are not limited to, signals that indicate the following: PLL (Phase Locked Loop) Locked, Measured SWR (Standing Wave Ratio), Power Consumption, and Tuning Coefficient. The RF modulator 102 is coupled with RF coupling and or resonance chamber (C). The resonance chamber (C) is spatially coupled with one or more heating elements (H), having a pre-set or known Curie temperature. The one or more heating elements are thermally coupled with the one or more blades (B), thus transferring heat energy directly to blades (B) of the razor. An energy source 100 provides the electric current that is required for operating the processing element 101 and RF modulator 102. The RF modulator 102 emits RF energy, directed and amplified by the RF coupling/resonance chamber (C), which in turn warms up the heating elements (H). The closer the temperature of the heating elements (H) is to the pre-set Curie temperature point, the less SWR is measured by the RF modulator 102, which in turn indicates processing element 101 to reduce the power limit to the levels that are necessary to sustain the required temperature of the heating elements (H). When water, skin and/or other elements come into contact with the blades (B), the thermal coupling to the heating elements (H) causes the temperature of the heating elements (H) to drift away from the pre-set Curie temperature, which in turn increases measured SWR, indicating to the processor element 101 to increase the power limit to the RF modulator 102, thus increasing the temperature of the one or more heating elements (H) closer to the Curie temperature, at which point the process repeats. The processing element 101 additionally monitors energy levels that are supplied by the energy source 100 in order to estimate the power limit that is available for disposal.

While the present invention has been shown and described in accordance with several preferred and practical embodiments, it is recognized that departures from the instant disclosure are fully contemplated within the spirit and scope of the invention which is limited only by the following claims as interpreted under the Doctrine of Equivalents.

What is claimed is:

1. A razor for shaving and comprising:
at least one blade;
a processing element;
a radio frequency modulator communicating with the processing element and being structured and disposed for generating and emitting radio frequency energy; and
a resonance chamber coupled with the radio frequency modulator and structured and disposed for amplifying the radio frequency energy emitted by the radio frequency modulator and directing the amplified radio frequency energy to cause the at least one blade to increase in temperature.

2. The razor as recited in claim 1 wherein the resonance chamber is spatially coupled with the at least one blade and the resonance chamber is structured and disposed for directing the amplified radio frequency energy onto the at least one blade to cause the at least one blade to increase in temperature.

3. The razor as recited in claim 2 wherein the razor includes a plurality of blades.

4. The razor as recited in claim 3 wherein the resonance chamber is spatially coupled with each of the plurality of blades and is structured for directing the amplified radio frequency energy onto each of the plurality of blades to cause each of the plurality of blades to increase in temperature.

5. The razor as recited in claim 1 wherein the processing element is structured and disposed for monitoring the temperature of the at least one blade and the processing element is further structured and disposed for increasing a power limit to the radio frequency modulator when the temperature of the at least one blade drifts below a predetermined temperature to thereby trigger generation and emission of the radio frequency energy by the radio frequency modulator to effectively maintain the temperature of the at least one blade within a desired temperature range.

6. The razor as recited in claim 4 wherein the processing element is structured and disposed for maintaining the temperature of the plurality of blades and the processing element is further structured and disposed for increasing a power limit to the radio frequency modulator when the temperature of the plurality of blades drifts below a predetermined temperature to thereby trigger generation and emission of the radio frequency energy to effectively maintain the temperature of the plurality of blades within a desired temperature range.

7. The razor as recited in claim 1 further comprising at least one heating element thermally coupled with the at least one blade and the resonance chamber is structured and disposed for directing the amplified radio frequency energy onto the at least one heating element thereby causing the at least one blade to increase in temperature.

8. The razor as recited in claim 3 further comprising at least one heating element thermally coupled with the plurality of blades and the resonance chamber is structured and disposed for directing the amplified radio frequency energy onto the at least one heating element thereby causing the plurality of blades to increase in temperature.

9. A razor for shaving and comprising:
at least one blade;
a processing element;
a radio frequency modulator communicating with the processing element and being structured and disposed for generating and emitting radio frequency energy; and
a radio frequency coupling coupled with the radio frequency modulator and structured and disposed for amplifying the radio frequency energy emitted by the radio frequency modulator and directing the amplified radio frequency energy to cause the at least one blade to increase in temperature.

10. The razor as recited in claim 9 wherein the radio frequency coupling is spatially coupled with the at least one blade and the radio frequency coupling is structured and disposed for directing the amplified radio frequency energy onto the at least one blade to cause the at least one blade to increase in temperature.

11. The razor as recited in claim 10 wherein the razor includes a plurality of blades.

12. The razor as recited in claim 11 wherein the radio frequency coupling is spatially coupled with each of the plurality of blades and is structured for directing the amplified radio frequency energy onto each of the plurality of blades to cause each of the plurality of blades to increase in temperature.

13. The razor as recited in claim 9 wherein the processing element is structured and disposed for monitoring the temperature of the at least one blade and the processing element is further structured and disposed for increasing a power limit to the radio frequency modulator when the temperature of the at least one blade drifts below a predetermined temperature to thereby trigger generation and emission of the radio frequency energy by the radio frequency modulator to effectively maintain the temperature of the at least one blade within a desired temperature range.

14. The razor as recited in claim 12 wherein the processing element is structured and disposed for maintaining the temperature of the plurality of blades and the processing element is further structured and disposed for increasing a power limit to the radio frequency modulator when the temperature of the plurality of blades drifts below a predetermined temperature to thereby trigger generation and emission of the radio frequency energy to effectively maintain the temperature of the plurality of blades within a desired temperature range.

15. The razor as recited in claim 9 further comprising at least one heating element thermally coupled with the at least one blade and the radio frequency coupling is structured and disposed for directing the amplified radio frequency energy onto the at least one heating element thereby causing the at least one blade to increase in temperature.

16. The razor as recited in claim 11 further comprising at least one heating element thermally coupled with the plurality of blades and the radio frequency coupling is structured and disposed for directing the amplified radio frequency energy onto the at least one heating element thereby causing the plurality of blades to increase in temperature.
